(19) United States
(12) Patent Application Publication
(10) Pub. No.: US 2015/0336435 A1
(43) Pub. Date: Nov. 26, 2015

(54) MAGNETIC MOUNT FOR TIRE PRESSURE SENSOR

(71) Applicant: Rimex Supply Ltd., Surrey (CA)

(72) Inventors: David Norman Laird, Abbotsford (CA); Matthew C. Silvestro, Oakville (CA); Dennis John Fortman, Marshall, TX (US); Jonathan Gregory Robertson, Langley (CA)

(73) Assignee: RIMEX SUPPLY LTD., Surrey (CA)

(21) Appl. No.: 14/287,005

(22) Filed: May 24, 2014

(51) Int. Cl. B60C 23/04

(52) U.S. Cl. CPC B60C 23/0493

(57) ABSTRACT

A magnetic mount for magnetically mounting a tire pressure sensor inside a vehicle tire has a flexible frame, a sensor mount atop the frame, a first neodymium magnet under a first end of the frame, and a second neodymium magnet under an opposed second end of the frame. The frame may be H-shaped, with an elongate central member, a first member extending transversely from a first end of the central member, and a second member extending transversely from an opposed second end of the central member. A first pad is fixed under the first member, a second pad is fixed under the second member, the first magnet is fixed under the first pad, and the second magnet is fixed under the second pad. Third and fourth magnets may be fixed under the first and second pads respectively. The magnets may be circular discs having a diameter of about ¾ inch.

### TECHNICAL FIELD

A magnetic mount is provided for magnetically mounting a tire pressure sensor inside a vehicle tire.

### BACKGROUND

The air pressure in vehicle pneumatic tires should be maintained within a particular range to protect against tire damage or failure, and to promote safe and efficient operation of the vehicle. Over-inflated or under-inflated tires may cause tire wear, internal tire damage, increased risk of tire penetration by sharp objects, blowouts and/or reduced vehicle fuel economy. A tire pressure monitoring system (TPMS) can be used to monitor air pressure inside a pneumatic tire and to generate an alert if the tire pressure falls outside of a desirable range for the tire. A TPMS may be used for monitoring air pressure in off-the-road (OTR) pneumatic tires used on large off-road vehicles such as mining trucks, construction vehicles or the like. A TPMS may incorporate a tire pressure sensor placed inside a tire and means for transmitting pressure information detected by the tire pressure sensor to a receiver.

A tire pressure sensor can be mounted inside a tire by vulcanizing the sensor to the tire when the tire is manufactured. Alternatively, an attachment mechanism such as a strap can be built into the tire when the tire is manufactured—the strap can then be fitted through or over a tire pressure sensor to mount the sensor inside the tire. Magnets can also be used to magnetically mount a tire pressure sensor inside a tire. However, these techniques are prone to failure—the sensor can become detached and will then tumble inside the tire until it fails.

There is a general desire to provide a tire pressure sensor mount which will overcome or at least ameliorate these and/or other drawbacks.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a front elevation view of a magnetic mount for a tire pressure sensor.

FIG. 2 is a top plan view of the FIG. 1 apparatus.

FIG. 3 is a bottom plan view of the FIG. 1 apparatus.

FIG. 4 is an oblique top isometric view of the FIG. 1 apparatus.

FIG. 5 is an oblique bottom isometric view of the FIG. 1 apparatus.

FIG. 6 is a fragmented, partially exploded, top plan view of a tool for installing, inside a tire, a tire pressure sensor mounted on the apparatus of FIGS. 1-5.

FIG. 7A is a side elevation view showing a tire pressure sensor oriented for engagement with the apparatus of FIGS. 1-5. FIG. 7B is a side elevation view showing the tire pressure sensor engaging the apparatus of FIGS. 1-5. FIG. 7C is a top plan view of the FIG. 7B tire pressure sensor and apparatus, oriented to engage the tool of FIG. 6.

FIG. 8A is an oblique top isometric view showing the tire pressure sensor and apparatus of FIGS. 7B and 7C, engaging the tool of FIG. 6. FIG. 8B is similar to FIG. 8A and depicts adjustment of the tool.

FIG. 9A is a top plan view of a coupler portion of the tool of FIG. 6, showing removal of a cotter pin therefrom. FIG. 9B is similar to FIG. 9A and depicts the installed cotter pin.

FIG. 10A is a side elevation view of a portion of the FIG. 6 tool engaging the tire pressure sensor and apparatus of FIGS. 7B and 7C, showing the tool positioned just prior to installation of the sensor on a wheel rim. FIG. 10B is similar to FIG. 10A and shows the tool positioned to install the sensor. FIG. 10C is similar to FIGS. 10A and 10B, and shows withdrawal of the tool after installation of the sensor.

FIG. 11A is a side elevation view of a horizontally positioned wheel rim, showing a tire pressure sensor engaging the apparatus of FIGS. 1-5, with the apparatus magnetically mounted on the rim. FIGS. 11B and 11C are side elevation views showing positioning of a tire for mounting on the FIG. 11A wheel rim.

FIG. 12A is a side elevation view of a vertically positioned wheel rim, showing a tire pressure sensor engaging the apparatus of FIGS. 1-5, with the apparatus magnetically mounted on the rim. FIGS. 12B, 12C and 12D are side elevation views showing positioning of a tire for mounting on the FIG. 12A wheel rim.

FIG. 13 is a side elevation view of a horizontally positioned wheel rim with a tire partially positioned over the rim, showing use of the FIG. 6 tool to magnetically mount on the rim (or to detach from the rim) a tire pressure sensor engaging the apparatus of FIGS. 1-5.

FIG. 14 is a fragmented oblique bottom isometric view depicting an alternative pad structure.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

FIGS. 1-5 depict a magnetic mount 10 for a tire pressure sensor. The tire pressure sensor is not shown in FIGS. 1-5 to avoid obscuring details of magnetic mount 10. The tire pressure sensor (which may be a TyreSense™ sensor available from Rimex Supply Ltd., Surrey, British Columbia, Canada) may be threadably fastened on mounting post 12.

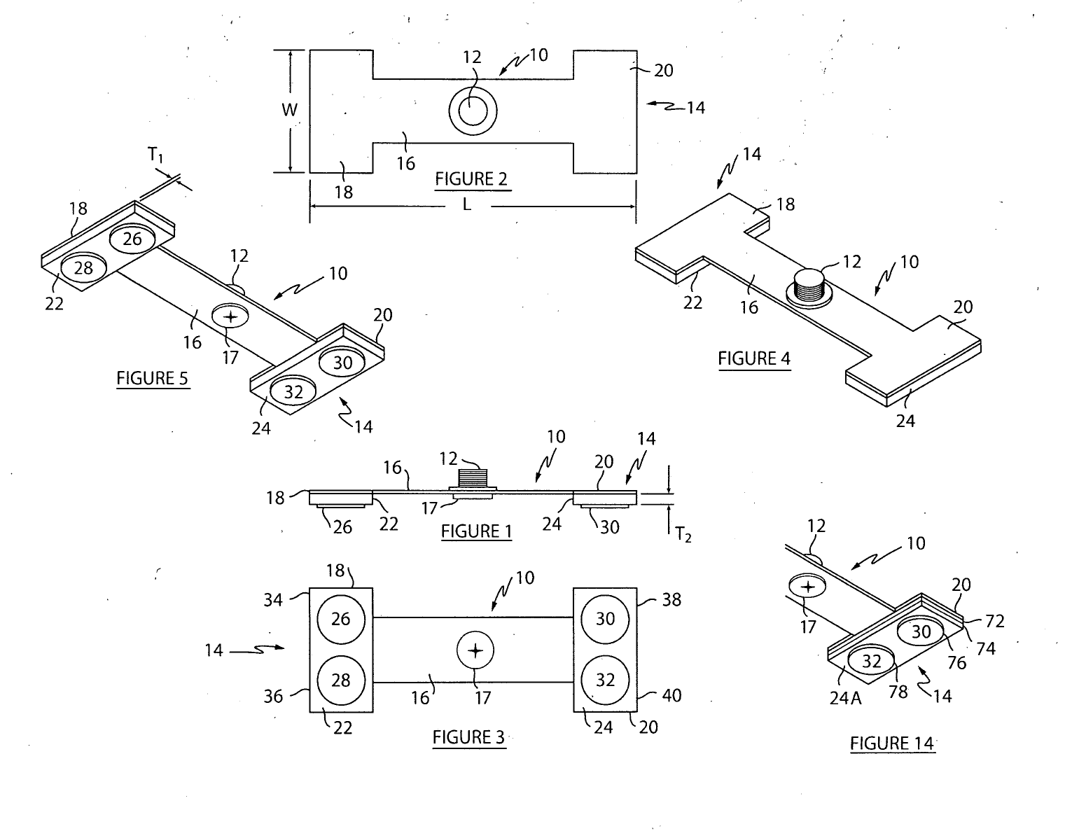

Magnetic mount 10 may include a generally H-shaped (e.g. as viewed in FIGS. 2 and 3) frame 14 having an elongate central member 16 with first and second members 18, 20 extending transversely outwardly from each opposed end of central member 16. Frame 14 including central member 16, first member 18 and second member 20 may be formed of a flexible material such as mild steel. Threaded mounting post 12, which may be made of brass, is fixed centrally atop central member 16 by passing a machine screw 17 through an aperture provided in the underside of central member 16 to threadably engage an aperture provided in the underside of mounting post 12. Loctite® thread locking adhesive may be applied to the machine screw's threads before the machine screw is installed as aforesaid.

A first pad 22 is fixed (e.g. spot welded) to the underside of first member 18. A second pad 24 is fixed (e.g. spot welded) to the underside of second member 20. First and second pads 22, 24 may be formed of a material such as mild steel.

As shown in FIG. 2, magnetic mount 10 may have a length dimension L of about 5½ inches (about 14 cm) and a width dimension W of about 2 inches (about 5 cm). As shown in FIG. 5, frame 14 including central member 16, first member 18 and second member 20 may have a thickness dimension T₁ of about 1/16 inch (about 0.16 cm). As shown in FIG. 1, first and second pads 22, 24 may each have a thickness dimension T₂ of about ¼ inch (about 0.65 cm).

First and second magnets 26, 28 are adhesively bonded or mechanically fastened (e.g. by screw fastening or by covering each magnet with a thin metal covering membrane) to the underside of first pad 22 to position first magnet 26 toward a first end 34 (FIG. 3) of first member 18 and to position second magnet 28 toward an opposed second end 36 of first member 18. Third and fourth magnets 30, 32 are adhesively bonded or mechanically fastened to the underside of second pad 24 to position third magnet 30 toward a first end 38 of second member 20 and to position fourth magnet 32 toward an opposed second end 40 of second member 20.

First, second, third and fourth magnets 26, 28, 30, 32 may be rare earth magnets, such as neodymium magnets. Each magnet may be a circular disc having a diameter of about ¾ inch (about 2 cm) and a thickness of about 3/16 inch (about 0.5 cm).

Is it not necessary to provide four magnets as shown. In some embodiments only two magnets may be provided: one at each opposed end of central member 16—in which case first and second members 18, 20 are not required. If only two magnets are provided, it may be desirable to use larger magnets capable of cumulatively exerting a magnetic gripping force approximately equal to the magnetic gripping force cumulatively exerted by first, second, third and fourth magnets 26, 28, 30, 32. If larger magnets are used, their shape may be altered to reduce the likelihood of forming gaps between the magnets and the surface (e.g. the arcuate surface of a wheel rim) to which the magnets are to be magnetically attached. For example, each larger magnet may have a rectangular shape approximately 1 inch (about 2.5 cm) by 2 inches (about 5 cm) and a thickness of about 3/16 inch (about 0.5 cm).

As a further alternative, in some embodiments only one magnet may be provided, centrally disposed between an opposed pair of rigid metallic bracing arms (not shown). A sensor mounting post (not shown) may be provided on the magnet. The bracing arms may have an arcuate shape conforming to the outer circumferential shape of a wheel rim. This allows the bracing arms to extend away from the magnet, in longitudinal opposition to one another and in circumferential alignment with the wheel rim when the magnet is magnetically attached to the wheel rim. The bracing arms assist in resisting forces which might dislodge a magnetically attached sensor from the wheel rim.

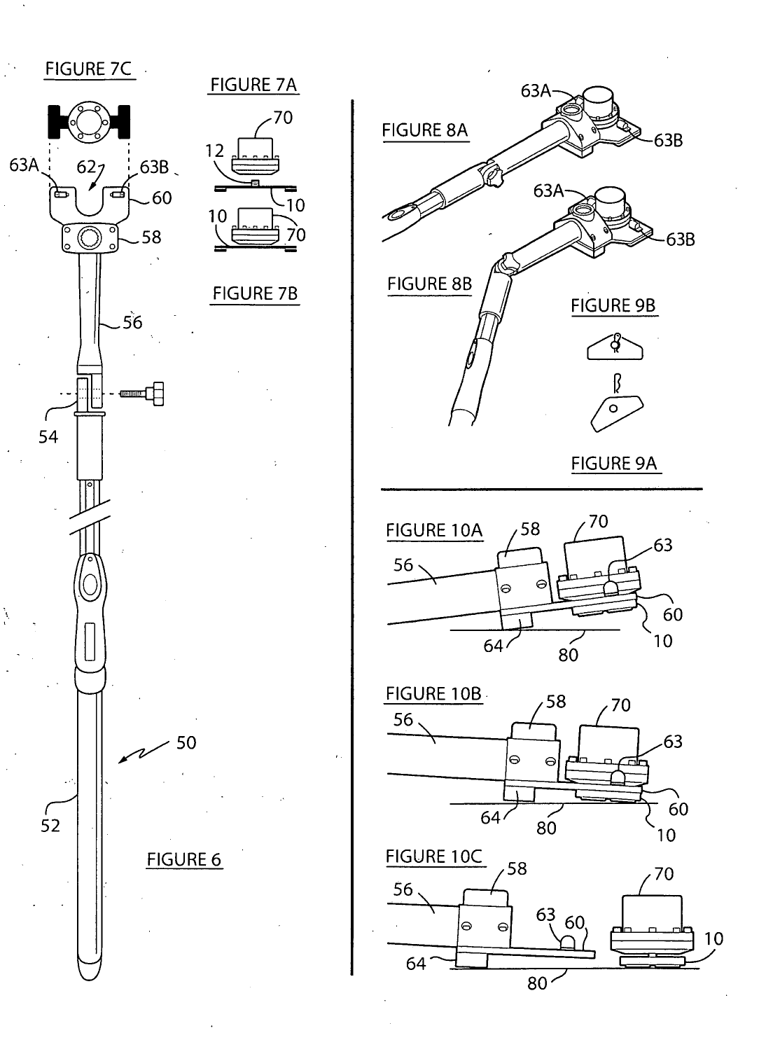

FIG. 6 depicts a tool 50 for installing magnetic mount 10 (including a tire pressure sensor mounted thereon) inside a tire. Tool 50 may have a telescopically extendible handle 52 pivotally coupled by first swivel joint 54 to neck 56. Second swivel joint 58 pivotally couples neck 56 to head 60. Head 60 has a U-shaped recess 62 for slidably receiving a tire pressure sensor mounted on magnetic mount 10.

As shown in FIG. 7A, tire pressure sensor 70 is positioned over magnetic mount 10's mounting post 12 then rotated to threadably fasten tire pressure sensor 70 on mounting post 12 as shown in FIG. 7B. Magnetic mount 10 bearing tire pressure sensor 70 is then oriented adjacent tool 50's head 60 and head 60 is slidably advanced over frame 14 as shown in FIG. 7C to position tire pressure sensor 70 within U-shaped recess 62. Since the underside of tire pressure sensor 70 is bevelled, tool 50's head 60 is captured between frame 14 and the underside of tire pressure sensor 70.

After tire pressure sensor 70 is positioned as aforesaid within U-shaped recess 62, first swivel joint 54 and/or second swivel joint 58 can be adjusted as shown in FIGS. 8A and 8B to place tool 50 in a configuration appropriate for magnetically attaching magnetic mount 10 (with tire pressure sensor 70 mounted thereon) to a wheel rim. U-shaped recess 62 may be equipped with spring-loaded catches 63A, 63B to retain sensor 70 within U-shaped recess 62 while tool 50 is manipulated as explained below.

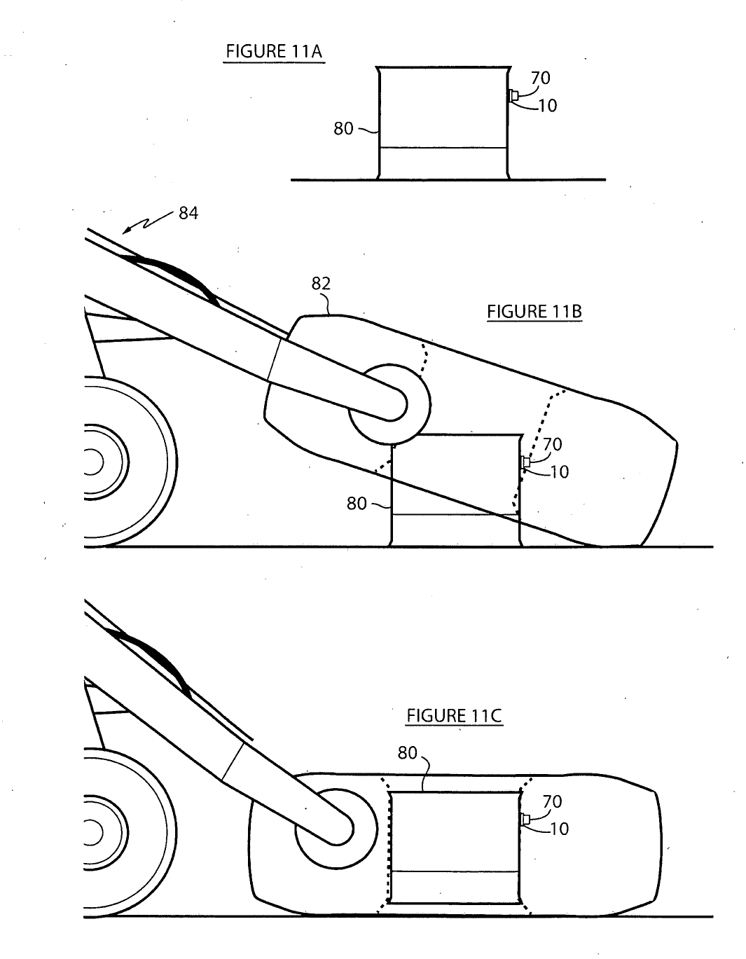

With tool 50 configured as aforesaid, tool 50 is initially manipulated as shown in FIG. 10A to rest plastic heel 64 provided on the underside of second swivel joint 58 on the surface (e.g. wheel rim 80—shown schematically only in FIGS. 10A, 10B and 10C) on which sensor 70 is to be magnetically mounted. As seen in FIG. 10A, tool 50 is manipulated such that head 60 is angled upwardly to hold sensor 70 away from wheel rim 80. Tool 50 is then manipulated as shown in FIG. 10B to dip head 60 downwardly toward wheel rim 80 until magnetic mount 10's magnets are magnetically attached to wheel rim 80. Tool 50 is then manipulated as shown in FIG. 10C to withdraw head 60 from magnetic mount 10 and senor 70, leaving magnetic mount 10 (with tire pressure sensor 70 mounted thereon) magnetically attached to wheel rim 80. Such manipulation and withdrawal overcomes the biasing force exerted by spring-loaded catches 63A, 63B thus releasing sensor 70 from U-shaped recess 62.

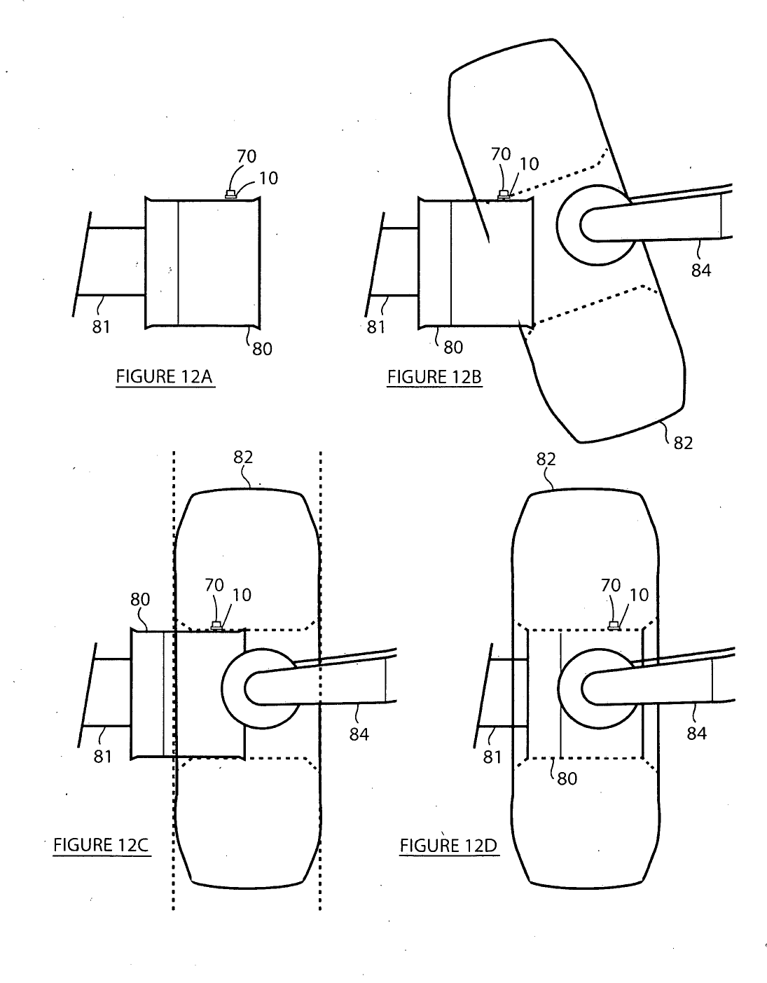

After magnetic mount 10 (with tire pressure sensor 70 mounted thereon) is magnetically attached as aforesaid to wheel rim 80, a tire can be mounted on wheel rim 80. FIGS. 11A-11C depict mounting of a tire with wheel rim 80 positioned horizontally. FIGS. 12A-12D depict mounting of a tire with wheel rim 80 positioned vertically.

Specifically, FIG. 11A depicts wheel rim 80 positioned horizontally with tire pressure sensor 70 magnetically attached to wheel rim 80 by magnetic mount 10. As shown in FIG. 11B, tire 82 is then grasped and manouevred by tire manipulator 84 to position tire 82 at an angle over wheel rim 80—care being taken to avoid contacting sensor 70 or magnetic mount 10 with tire 82 since such contact may dislodge sensor 70 and magnetic mount 10 from wheel rim 80. As shown in FIG. 11C, tire 82 is then slowly lowered over wheel rim 80 by tire manipulator 84 to position tire 82 on wheel rim 80, leaving magnetic mount 10 (with tire pressure sensor 70 mounted thereon) magnetically attached to wheel rim 80 inside tire 82.

FIG. 12A depicts wheel rim 80 positioned vertically on vehicle axle 81, with tire pressure sensor 70 magnetically attached to wheel rim 80 by magnetic mount 10. As shown in FIG. 12B, tire 82 is then grasped and manouevred by tire manipulator 84 to position tire 82 at an angle over wheel rim 80—care being taken to avoid contacting sensor 70 or magnetic mount 10 with tire 82 since such contact may dislodge sensor 70 and magnetic mount 10 from wheel rim 80. As shown in FIG. 12C, tire 82 is then slowly rotated by tire manipulator 84 to orient tire vertically relative to wheel rim 80. As shown in FIG. 12D, tire 82 is then slowly slidably horizontally advanced over wheel rim 80 by tire manipulator 84 to position tire 82 on wheel rim 80, leaving magnetic mount 10 (with tire pressure sensor 70 mounted thereon) magnetically attached to wheel rim 80 inside tire 82.

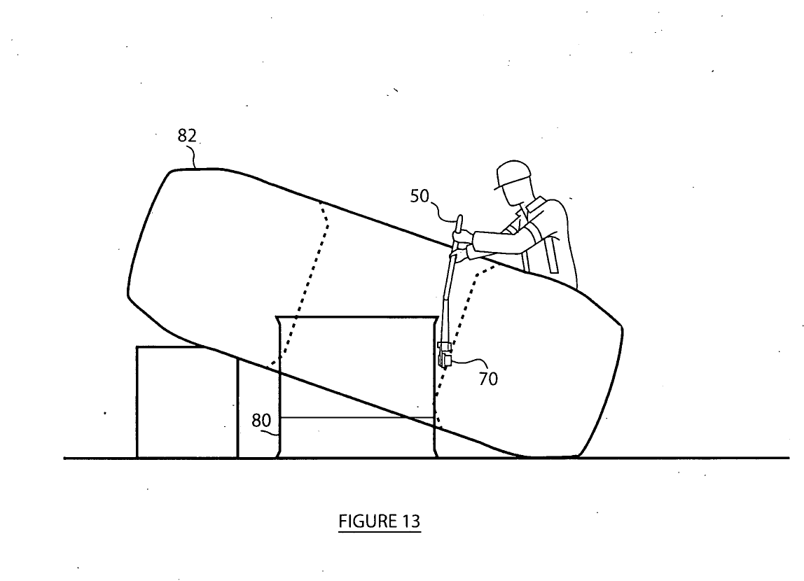

FIG. 13 depicts an alternative technique for magnetically attaching magnetic mount 10 (with tire pressure sensor 70 mounted thereon) to wheel rim 80 after tire 82 has been positioned as shown at an angle over wheel rim 80. The same technique can be used to detach magnetic mount 10 and tire pressure sensor 70 from wheel rim 80.

In the attachment case, tool 50 is configured and manipulated as previously described in relation to FIGS. 10A-10C, leaving magnetic mount 10 (with tire pressure sensor 70 mounted thereon) magnetically attached to wheel rim 80. Tire 82 is then installed over wheel rim 80 as previously described in relation to FIGS. 11B and 11C.

In the detachment case, tool 50 is configured as previously described in relation to FIGS. 10A-10C, and then manipulated as previously described in relation to FIG. 7C (but this time relative to magnetic mount 10 and sensor 70 magnetically attached to wheel rim 80) to position tire pressure sensor 70 within tool 50's U-shaped recess 62. Tool 50 is then manipulated as shown in FIGS. 7A and 13 to pry magnetic mount 10 and sensor 70 away from wheel rim 80. Tool 50, magnetic mount 10 and sensor 70 are then withdrawn from tire 82. Magnetic mount 10 and sensor 70 are then removed from tool 50's U-shaped recess 62.

The flexible characteristic of magnetic mount 10's frame 14 permits frame 14 to bend to conform to the arcuate shape of wheel rim 80, reducing the distance between wheel rim 80 and each of magnets 26, 28, 30, 32 respectively and thus improving magnetic attachment of each magnet to wheel rim 80. Use of a plurality of small diameter (e.g. about ¾ inch or 2 cm) magnets 26, 28, 30, 32 provides multiple contact points to further improve magnetic attachment of magnetic mount 10 to wheel rim 80. Magnets 26, 28, 30, 32 may each be a lightweight (e.g. about 0.5 ounce or 15 gram) neodymium magnet capable of exerting a gripping force of about 20 lbs. (about 9 kg) relative to a flat surface, enabling the magnets to bend magnetic mount 10's flexible frame 14 to conform to the arcuate shape of wheel rim 80 and thus improve magnetic attachment of each magnet to wheel rim 80 as aforesaid.

Larger diameter (e.g. about 2½ inch or 6.5 cm) neodymium magnets capable of exerting a larger (e.g. about 60 lbs. or 27 kg) gripping force relative to a flat surface could be substituted for the aforementioned small diameter magnets. However, if a larger diameter magnet having a flat disc shape is placed on an arcuate wheel rim surface, then the magnet's gripping force relative to the arcuate surface is reduced since only a reduced portion of the magnet contacts the arcuate surface. Moreover, larger diameter magnets are heavier—for example, a 2½″ neodymium magnet typically weighs about 5½ ounces. The increased weight is generally undesirable since it can result in increased centrifugal forces as mentioned below.

Typical OTR wheel diameters range from about 25″ to 63″ (about 63 cm to 160 cm). A 2½″ diameter magnet can exert a particular gripping force on a 63″ diameter wheel rim, but may exert a significantly reduced gripping force on a 25″ diameter wheel rim, due to the formation of gaps between the magnet and the arcuate surface of the wheel rim.

Off road vehicles such as mining trucks operate on uneven surfaces and can travel at significant speeds (e.g. about 50 mph or 80 kph). Consequently, high centrifugal forces and high impact forces can be encountered inside an OTR vehicle tire. The centrifugal forces increase in proportion to weight, so it is desirable to reduce the weight of magnetic mount 10 including the weight of the magnets. Strong magnets (i.e. magnets capable of exerting high gripping forces) are desirable in order to resist the centrifugal and impact forces. Larger magnets provide stronger gripping forces, but tradeoffs are required since heavier, larger diameter magnets may be unable to resist the aforementioned centrifugal and impact forces, potentially resulting in dislodgement of magnetically mounted sensor 70 from wheel rim 80.

Smaller diameter magnets can also impede incursion of foreign matter into gaps between the magnets and the wheel rim, particularly if flat magnets which are not shaped in conformity to the arcuate surface of wheel rim 80 are used. A magnet's gripping force can be reduced if foreign matter is allowed to intrude and accumulate between the magnet and the wheel rim. Ferromagnetic foreign matter is commonly encountered inside a tire mounted on the wheel rim of an off road vehicle such as a mining truck.

While a number of exemplary aspects and embodiments have been discussed above, those of skill in the art will recognize certain modifications, permutations, additions and sub-combinations thereof.

For example, instead of fixing mounting post 12 atop central member 16, the mounting post could be formed integrally with and on the underside of tire pressure sensor 70.

As a further alternative, mounting post 12 could be eliminated and tire pressure sensor 70 could be fixed atop central member 16 by passing a machine screw through an aperture provided in the underside of central member 16 to threadably engage an aperture provided in the underside of tire pressure sensor 70.

As a still further alternative, pads 22, 24 may each be formed with dual layers as shown in FIG. 14, which depicts an alternative pad 24A having an inward layer 72 and an outward layer 74. Inward layer 72 and outward layer 74 are formed of mild steel. Inward layer 72 is spot welded to frame 14's second member 20. Magnet-receiving apertures 76, 78 are formed (e.g. stamped) in outward layer 74. Outward layer 74 is spot welded to inward layer 72. Magnets 30, 32 are adhesively bonded or mechanically fastened within apertures 76, 78 respectively. The dual layer structure of pad 24A reduces manufacturing costs and simplifies bonding or fastening of magnets 30, 32 to magnetic mount 10.

The scope of the claims should not be limited by the preferred embodiments set forth herein, but should be given the broadest interpretation consistent with the description as a whole.

What is claimed is:

1. A magnetic mount for magnetically mounting a tire pressure sensor inside a vehicle tire, the magnetic mount comprising:
a flexible frame;
a tire pressure sensor mount atop the frame;
a first magnet fixed under the frame at a first end of the frame; and
a second magnet fixed under the frame at a second end of the frame opposite the first end of the frame.

2. A magnetic mount as defined in claim 1, wherein the frame is H-shaped.

3. A magnetic mount as defined in claim 1, wherein the frame further comprises:
an elongate central member;
a first member extending transversely outwardly from a first end of the central member;
a second member extending transversely outwardly from a second end of the central member opposite the first end of the central member;
wherein:
the first magnet is fixed under the first member; and
the second magnet is fixed under the second member.

4. A magnetic mount as defined in claim 1, wherein the tire pressure sensor mount further comprises a post fixed centrally atop the central member.

5. A magnetic mount as defined in claim 3, further comprising:
a first pad fixed to an underside of the first member;
a second pad fixed to an underside of the second member;
wherein:
the first magnet is fixed to an underside of the first pad; and
the second magnet is fixed to an underside of the second pad.

6. A magnetic mount as defined in claim 5, wherein:
the first magnet is adhesively bonded to the underside of the first pad; and
the second magnet is adhesively bonded to the underside of the second pad.

7. A magnetic mount as defined in claim 5, further comprising:
a third magnet fixed to the underside of the first pad;
a fourth magnet fixed to the underside of the second pad;
wherein:
the first magnet is positioned toward a first end of the first member;
the second magnet is positioned toward a first end of the second member;
the third magnet is positioned toward a second end of the first member, opposite the first end of the first member; and
the fourth magnet is positioned toward a second end of the second member, opposite the first end of the second member.

8. A magnetic mount as defined in claim 1, wherein the magnets are neodymium magnets.

9. A magnetic mount as defined in claim 7, wherein the magnets are neodymium magnets.

10. A magnetic mount as defined in claim 8, wherein each one of the magnets is a circular disc having a diameter of about ¾ inch.

11. A magnetic mount as defined in claim 9, wherein each one of the magnets is a circular disc shape having a diameter of about ¾ inch.

12. A magnetic mount as defined in claim 8, wherein each one of the magnets has a rectangular shape.

13. A magnetic mount as defined in claim 10, wherein the frame has a length dimension L of about 5½ inches, a width dimension W of about 2 inches and a thickness dimension T₁ of about 1/16 inch.

14. A magnetic mount as defined in claim 8, wherein each one of the magnets has a rectangular shape approximately 1 inch wide, approximately 2 inches long and approximately 3/16 inch thick.

15. A method of magnetically mounting a tire pressure sensor inside a vehicle tire, the method comprising:
flexibly coupling a first magnet to the sensor; and
flexibly coupling a second magnet to the sensor at a location spaced apart from the first magnet.

16. A method as defined in claim 15, further comprising flexibly coupling a third magnet to the sensor at a location spaced apart from the first magnet and spaced apart from the second magnet.

17. A method as defined in claim 16, further comprising flexibly coupling a fourth magnet to the sensor at a location spaced apart from the first, second and third magnets.

18. A magnetic mount for magnetically mounting a tire pressure sensor inside a vehicle tire, the magnetic mount comprising:
a magnet centrally disposed between an opposed pair of bracing arms; and
a tire pressure sensor mount on the magnet.

19. A magnetic mount as defined in claim 18, wherein:
the tire is mountable on a wheel rim; and
the bracing arms are shaped to conform to an outer circumferential shape of the wheel rim.

20. A magnetic mount as defined in claim 19, wherein the bracing arms are rigid and metallic.
